(19) United States
(12) Patent Application Publication
(10) Pub. No.: US 2002/0172547 A1
(43) Pub. Date: Nov. 21, 2002

(54) Structure steel cable lug fitting

(76) Inventor: Steven Hong, Taichung (TW)

Correspondence Address: Dougherty & Troxell, ONE SKYLINE PLACE, 5205 LEESBURG PIKE, SUITE 1404, FALLS CHURCH, VA, 22041, US

(21) Appl. No.: 09/859,529

(22) Filed: May 18, 2001

(51) Int. Cl. F16B 1/00; B25G 3/28; F16G 11/00

(52) U.S. Cl. 403/278

(57) ABSTRACT

An improved structure steel cable lug fitting, wherein the lug fitting accommodates the insertion and fixing of a steel cable at one side and has a suspending end with a hole in the center on the other side. The lug fitting has a shallow annular groove formed around it that provides for the seating of a tubular roller wheel. The innovative features are that the annular groove of the lug fitting is situated at the suspending end and, furthermore, a diversion hole is disposed in the bottom plane of the annular groove such that when the steel cable is inserted, it functions as a visual access opening to examine that the steel cable is correctly positioned. Furthermore, during the continuous heat treatment process, the diversion hole provides for circulating out heated gases from the interior section to achieve efficient and thorough tempering such that metal material strength and resiliency meets expected criteria.

### BACKGROUND OF THE INVENTION

1) Field of the Invention

The invention herein relates to an improved structure steel cable lug fitting in which a diversion hole is disposed in the circumferential surface at the suspending end of the lug fitting and, furthermore, after the steel cable is inserted, the said diversion hole forms a visual access opening to examine whether the steel cable is correctly positioned to ensure that when a roller wheel press rolls the lug fitting, the steel cable and the lug fitting are rolled into conjoinment at an annular groove as a single structural entity; furthermore, since the diversion hole is situated at the compressive rolling position of the lug fitting such that heated gases are circulated out of the diversion hole during the heat tempering process, tempering is efficient and thorough to thereby enable metal material strength and resiliency to meet expected criteria.

2) Description of the Prior Art

In a conventional steel cable lug fitting structure, as indicated in FIG. 1. and FIG. 2, the said lug fitting 5 is a cylindrical tube-like structure, the lug fitting 5 having a barrel 51 disposed through one side that provides for the insertion of the steel cable 2 into the barrel 51 and its press rolling into position; formed at the other side is a suspending end 52 having a hole 521 in the center; the said lug fitting 5 has a slightly indented step 53 around its extremity that provides for the seating of a tubular roller wheel 3 against the step 53 for press rolling; however, the said lug fitting is subject to the limitations of its structural features, resulting in various practical drawbacks that are summarized as follows:

1. When the lug fitting 5 is sleeved onto the steel cable 2, since the circumferential surface along the entire tubular extent of the lug fitting 5 is sealed, it is not possible to observe the length of the steel cable 2 already inserted into the barrel 51 or whether the tubular body is blocking further insertion after only a small portion of the steel cable 2 is inserted; as such, this easily results in no conjoinment when the lug fitting 5 and the steel cable 2 are press rolled together, or the steel cable 2 is snagged at the press rolling area such that during press rolling, only a minor or partial section of the steel cable 2 is rolled (as shown in FIG. 1A), resulting in an unreliable conjoinment between the lug fitting 5 and the steel cable 2 as well as the risk of dangerous separation.

2. After press rolling, the lug fitting 5 must undergo a heat tempering process to maintain metal material strength and resiliency; however, during heat treatment, since the conventional lug fitting 5 lacks heat dispersal design considerations, heated gases cannot be directed away during the heat tempering process, resulting in substantially less heat tempering efficiency such that metal material strength and resiliency fail to meet expected criteria and renders utilization hazardous.

### SUMMARY OF THE INVENTION

The primary objective of the invention herein is to provide an improved structure steel cable lug fitting, wherein the lug fitting accommodates the insertion and fixing of a steel cable at one side and has a suspending end with a hole in the center on the other side; the said lug fitting has a shallow annular groove formed around it that provides for the seating of a tubular roller wheel; the innovative features are that the annular groove of the said lug fitting is situated at the suspending end and, furthermore, a diversion hole is disposed in the bottom plane of the annular groove such that when the steel cable is inserted, it forms a visual access opening to examine that the steel cable is correctly positioned to ensure that when the roller wheel press rolls the lug fitting, the steel cable and the lug fitting are rolled into conjoinment at the annular groove as a single structural entity.

Another objective of the invention herein is to provide an improved structure steel cable lug fitting, wherein since the diversion hole is situated at the compressive rolling position of the lug fitting, heated gases are circulated out of the diversion hole during the heat tempering process such that tempering is efficient and thorough, thereby enabling metal material strength and resiliency to meet expected criteria.

To enable a further understanding of the technological means as well as the achieved functions and objectives of the invention herein, the general embodiments are accompanied below by the drawings, the brief description of the drawings, and the detailed description of the invention herein.

### BRIEF DESCRIPTION OF THE DRAWINGS

FIG. 1 is an isometric drawing of a conventional lug fitting.

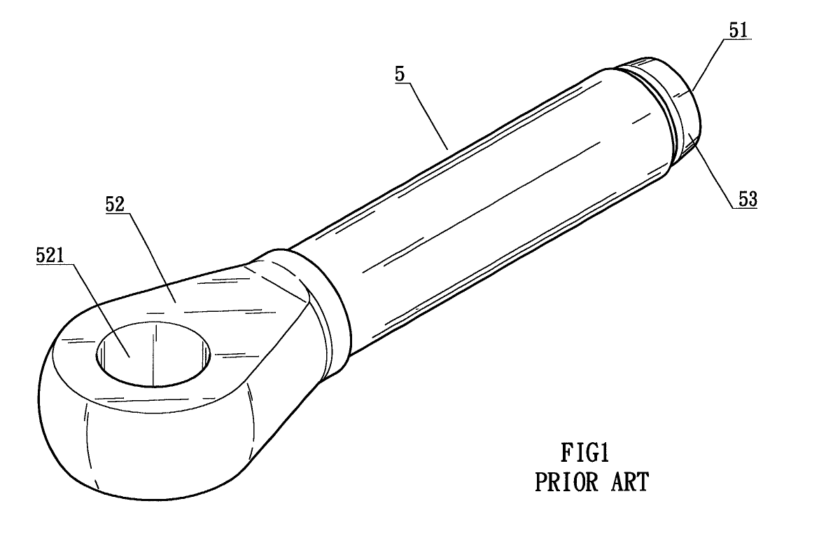

FIG. 1-A is a cross-sectional drawing of a conventional lug fitting after rolling.

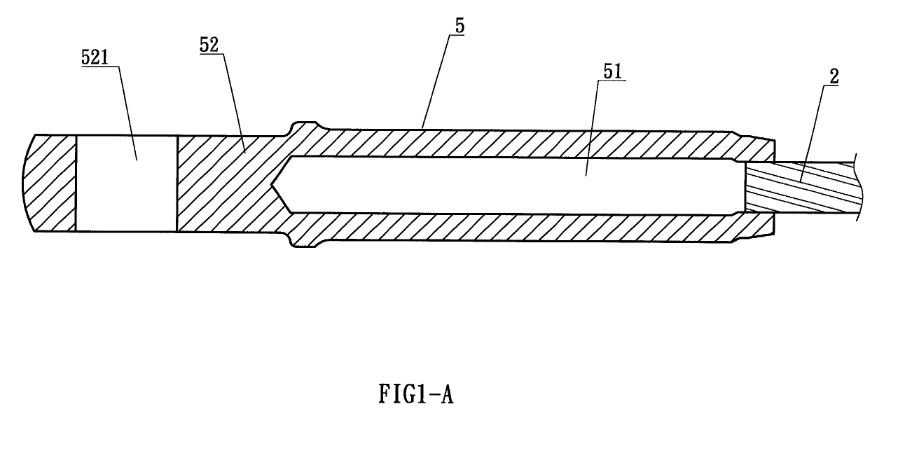

FIG. 2 is an isometric drawing of the invention herein.

FIG. 3 is a cross-sectional drawing of the invention herein before rolling.

FIG. 4 is a cross-sectional drawing of the invention herein after rolling.

### DETAILED DESCRIPTION OF THE INVENTION

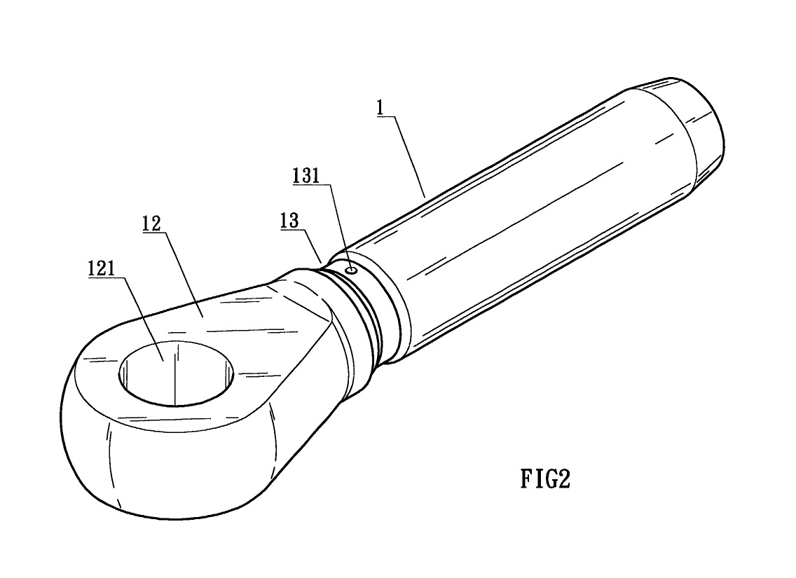

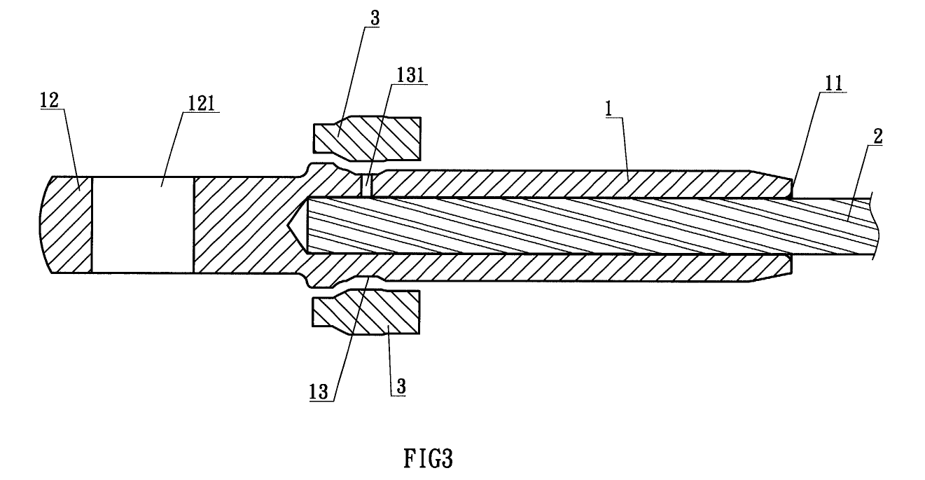

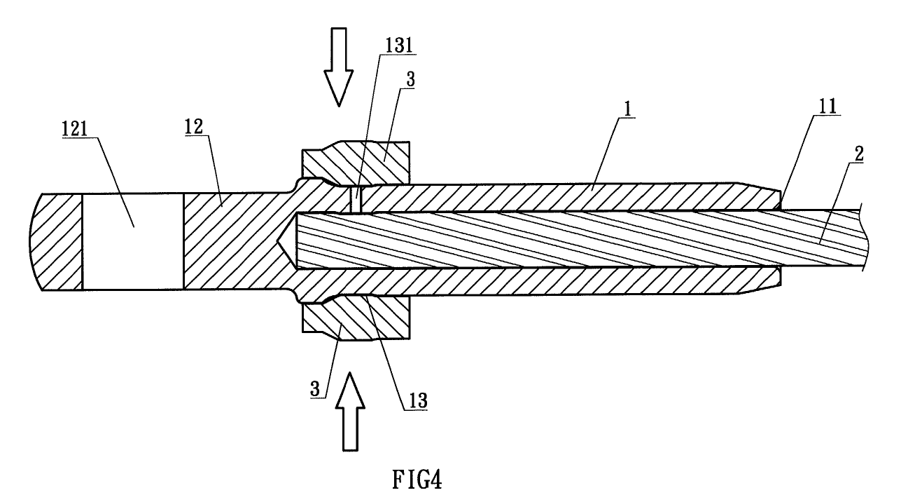

Referring to FIG. 2, FIG. 3, and FIG. 4, the structural arrangement of the present invention, the invention herein is comprised of a lug fitting 1 and a steel cable 2 situated at the interior section of the lug fitting 1, of which:

The said lug fitting 1 is of a cylindrical rod-like structure, the lug fitting 1 having a barrel 11 disposed through one side that provides for the insertion of the steel cable 2 into the barrel 11 and its press rolling into position; formed at the other side is a suspending end 12 of a planar profile and, furthermore, having a hole 121 in the center; the said lug fitting 1 has a shallow annular groove 13 formed around it that provides for the seating of a tubular roller wheel 3 along the annular groove 13 for press rolling; furthermore, when the said lug fitting 1 is press rolled, the annular groove 13 position provides for material retention after the compressive rolling process to prevent the occurrence of extrusion.

The innovative features are that the annular groove 13 of the said lug fitting 1 is situated at the suspending end 12 and, furthermore, a diversion hole 131 is disposed in the bottom plane of the annular groove 13 such that after the steel cable 2 is inserted, it forms a visual access opening to examine whether the steel cable 2 is correctly positioned to ensure that when the roller wheel 3 press rolls the lug fitting 1, the steel cable 2 and the lug fitting 1 are rolled into conjoinment as a single structural entity; the diversion hole 131 of the said lug fitting 1 also allows for the venting of heated gases through the diversion hole 131 during the heat tempering process, thereby facilitating heated gas circulation.

Since the said lug fitting 1 has a diversion hole 131 disposed in the bottom plane of the annular groove 13, after the steel cable 2 is inserted, it serves as a visual access opening to examine whether the steel cable 2 is correctly positioned; furthermore, heated gases are circulated out of the diversion hole 131 as the lug fitting 1 undergoes the heat tempering process, the rolled conjoinment of the steel cable 2 and the lug fitting 1 into a single structural entity is ensured and, furthermore, the heat tempering process is efficiently and thoroughly completed such that metal material strength and resiliency meets expected criteria.

1. An improved structure steel cable lug fining comprised of a lug fitting and a steel cable, wherein:
The said lug fitting has a barrel disposed through one side that provides for the insertion of the said steel cable and formed at the other side is a suspending end having a hole in the center; and the said lug fitting has a shallow annular groove formed around it that provides for the seating of a tubular roller wheel along the said annular groove for press rolling:
The innovative features are that the said annular groove of the said lug fitting is situated at the said suspending end and, furthermore, a diversion hole is disposed in the said annular groove such that after the said steel cable is inserted, it forms a visual access opening to examine whether the said steel cable is correctly positioned to ensure that when the said roller wheel press rolls the said lug fitting, the said steel cable and the said lug fitting are rolled into conjoinment at the said annular groove as a single structural entity; the said diversion hole of the said lug fitting also allows for the venting of heated gases through the said diversion hole during the heat tempering process, thereby facilitating heated gas circulation and enabling the heat tempering process to be efficiently and thoroughly completed such that metal material strength and resiliency meets expected criteria.

2. As mentioned in claim 1 of the improved structure steel cable lug fitting of the invention herein, the said annular groove of the said lug fitting provides for material retention after the compressive rolling process to prevent the occurrence of extrusion.
